(19) United States
(12) Patent Application Publication
(10) Pub. No.: US 2009/0207761 A1
(43) Pub. Date: Aug. 20, 2009

(54) FDD INBAND BACKHAULING AND METHOD THEREOF

(75) Inventors: Michael Tangemann, Leonberg (DE); Hardy Halbauer, Ettlingen (DE)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/372,408

(22) Filed: Feb. 17, 2009

(30) Foreign Application Priority Data
Feb. 18, 2008 (EP) 08 290 165.3

(51) Int. Cl. H04L 5/14; H04W 36/00

(52) U.S. Cl. 370/281; 455/436

(57) ABSTRACT

The present invention relates to an FDD Inband backhauling method for establishing a wireless transmission from at least one access base station to a master base station in a digital cellular communication system, the access base station coupled to at least a mobile station, the access base station coupled to a relay base station, the relay base station coupled to the master base station, the master base station coupled to a core network. The method comprises the steps of: receiving a first signal (s1) by the access base station from the mobile station using a first frequency band (f1); transforming the first frequency band (f1) of the first signal (s1) into the second frequency band (f2) by the access base station; and transmitting the first signal (s1) from the access base station to the relay base station using the second frequency band (f2). The method further comprises the steps of: transforming the second frequency band (f2) of the first signal (s1) into the first frequency band (f1) by the relay base station; and transmitting the first signal (s1) from the relay base station to the master base station using the first frequency band (f1).

The invention is based on a priority application EP 08 290 165.3 which is hereby incorporated by reference.

### TECHNICAL FIELD

This invention relates to FDD inband backhauling and, more specifically to a method for establishing a wireless transmission between an access base station to a master base station.

### BACKGROUND OF THE INVENTION

A duplex communication system is a system composed of two devices that can communicate in both directions. In half-duplex, the communication cannot be completed in both directions simultaneously, and one of the devices receives a signal, and waits for the transmitter to stop transmitting before replying. In full-duplex, the communication is completed simultaneously, which is typically the case for digital mobile communication systems such as UMTS, WiMAX (IEEE 802.16) or Long Term Evolution (LTE). The full-duplex communication can be further divided into frequency-division duplex (FDD) or time-division duplex (TDD). In time-division duplex, the transmitter and receiver use different time slots, with a time separation that is not perceived by the end users. In frequency-division duplex (FDD), the transmission and reception uses different operating frequencies. A frequency offset between both transmitter and receiver frequencies is required in order to filter the transmitting and receiving signals and avoid interference between both signals.

In digital mobile communication systems, a mobile station communicates with an access point or access base station, and the signals from all access base stations are transmitted to one or more master base station. This transportation is known as backhauling. Therefore a method of FDD inband backhauling in a digital cellular communication system from an access base station to a master base station, to a relay base station and a computer program product adapted for performing the method in accordance with the invention is needed.

### SUMMARY OF THE INVENTION

The present invention provides an FDD inband backhauling method for establishing a wireless transmission from at least one access base station to a master base station in a digital cellular communication system, the access base station is coupled to at least a mobile station, the access base station is coupled to a relay base station, the relay base station is coupled to the master base station, and the master base station is coupled to a core network. The method comprises the steps of: receiving a first signal s1 by the access base station from the mobile station using a first frequency band f1; transforming the first frequency band f1 of the first signal s1 into the second frequency band f2 by the access base station; and transmitting the first signal s1 from the access base station to the relay base station using the second frequency band f2, wherein the access base station is adapted for transmission using the second frequency band f2.

The method further comprises the steps of: transforming the second frequency band f2 of the first signal s1 into the first frequency band f1 by the relay base station, wherein the relay base station is adapted for transmission using the first frequency band f1; and transmitting the first signal s1 from the relay base station to the master base station using the first frequency band f1. The transformation of the frequency bands of the signal from a first frequency f1 to a second frequency f2 or vice-versa may be achieved through demodulation and modulation of the signal, or any other frequency conversion technique.

One of the advantage of the embodiments is that the backhauling in inband frequency-division duplex (FDD) allows an extended coverage of remote locations using a fast network rollout, and reusing the same frequency bands that are used for communication with the mobile stations. A further advantage is that the base stations are not required to transmit and receive using the same frequency band, as a first frequency band is used for transmission and a second frequency band is used for receiving signals from other base stations or mobile stations.

In accordance with an embodiment of the invention, the method further comprises the steps of: receiving a second signal s2 by the relay base station from the master base station using the second frequency band f2; transforming the second frequency band f2 of the second signal s2 into the first frequency band f1 by the relay base station; and transmitting the second signal s2 from the relay base station to the access base station using the first frequency band f1. The method further comprises the steps of: transforming the first frequency band f1 of the second signal s2 into the second frequency band f2 by the access base station; and transmitting the second signal s2 from the access base station to the mobile station using the second frequency band f2.

In accordance with an embodiment of the invention, the digital cellular communication system complies with the IEEE 802.16 and/or Long Term Evolution (LTE) standards. In accordance with an embodiment of the invention, the base stations further comprise a directional antenna for extending signal transmission reach.

In another aspect, the invention relates to a computer program product stored on a computer usable medium, comprising computer readable program means for causing a computer to perform a method according to any of the preceding claims 1 to 5 when the program is run on the computer.

In another aspect, the invention relates to a first relay base station in a digital cellular communication system, the cellular communication system further comprises an access base station coupled to the first relay base station, the first relay base station coupled to a second base station. The first relay base station comprises: means for receiving a first signal s1 from the access base station using the second frequency band f2, wherein the first relay base station is adapted for receiving using the second frequency band f2; and means for transforming the second frequency band f2 of the first signal s1 into the first frequency band f1, wherein the first relay base station is adapted for transmitting using the first frequency band f1.

The method further comprises: means for transmitting the first signal s1 to the second base station using the first frequency band f1; means for receiving a second signal s2 from the second base station using the second frequency band f2; means for transforming the second frequency band f2 of the second signal s2 into the first frequency band f1; and means for transmitting the second signal s2 to the access base station using the first frequency band f1.

An advantage of the embodiments is that there is no need to design a completely different relay base station, as most of the hardware used for the access and master base station can also be used for the relay base station (BS). The relay BS only requires to invert the transmission and reception carrier frequencies or, alternatively, to use a different transmitter and receiver hardware.

In another preferred embodiment, the second base station is a master base station, the master base station is coupled to a core network, the master base station adapted for communicating from a plurality of access base station within the digital cellular communication system.

In accordance with an embodiment of the invention, the second base station is coupled to a third relay base station, the third relay base station coupled to a master base station, the master base station adapted for receiving communication from a plurality of access base station within the digital cellular communication system, wherein the second base station is adapted to communicate with a plurality of mobile stations, wherein the third relay station is a first relay station as described in the embodiments of the invention.

### BRIEF DESCRIPTION OF THE DRAWINGS

In the following preferred embodiments of the invention will be described in greater detail by way of example only making reference to the drawings in which:

FIG. 1 shows a block diagram of a digital cellular communication system according to an embodiment of the invention,

FIG. 2 shows a second block diagram of a digital cellular communication system according to a further embodiment of the invention,

FIG. 3 shows a relay base station according to a further embodiment,

FIG. 4. shows a flow diagram according to a further embodiment.

### DETAILED DESCRIPTION OF PREFERRED EMBODIMENTS

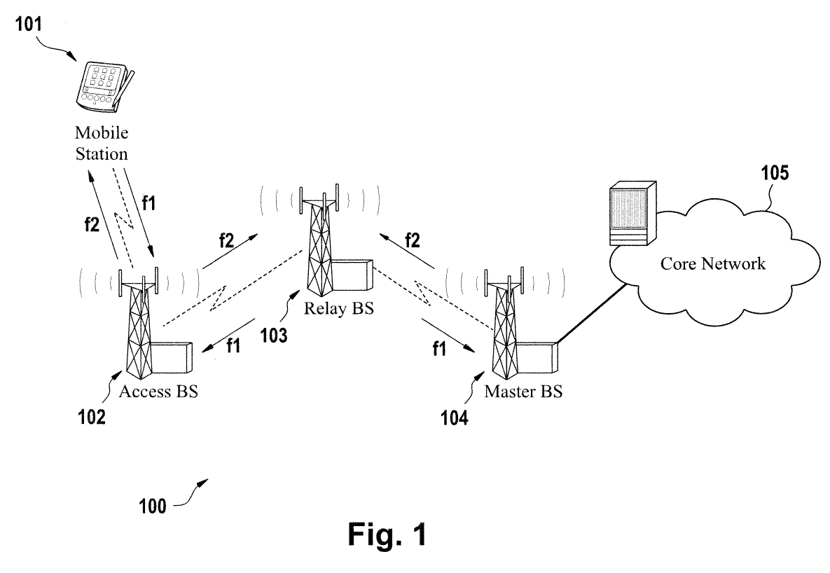

FIG. 1 shows a block diagram of a digital cellular communication system 300 comprising at least a mobile station 101 coupled to an access base station 102, the access base station 102 coupled to a relay base station 103, the relay base station 103 coupled to a master base station 104, the master base station 104 coupled to a core network 105.

When a mobile station 101 communicates with an access base station 102, it uses a first frequency band f1 in the uplink direction and when the access base station 102 communicates to the mobile station 101 in the downlink direction, it uses a second frequency band f2. If the mobile station 101 transmits the first signal to the access base station 102 using the first frequency band, the access base station 102 converts the signal into the second frequency band, so that the access base station 102 can transmit the first signal to the relay base station 103 using the second frequency band f2. The demodulation and modulation or any other technique of frequency conversion can be used. All the signals that are transmitted from the mobile station 101 to the access base station 102 are transformed and transmitted to the relay base station 103 using the second frequency band. The relay base station 103 receives the signal coming from the access base station 102 and converts the signal using as a carrier frequency the first frequency f1, in order to communicate and transmit the signal to the master base station 104. As the master base station 104 is coupled to the core network 105, the signal reaches the final destination as, for example, to another mobile station located in another access base station.

If a second signal is transmitted from the master base station and its final destination is the mobile station 101, the master base station 104 first communicates with the relay base station 103 using a second frequency band f2; the relay base station 103 will transform the signal and change the carrier frequency into the first frequency band f1 in order to communicate and transmit the signal to the access base station 102. The access base station 102 converts the second signal to second frequency band f2, so that the mobile station receives in the down ink direction the second signal f2. As the relay base station 103 transmits using a first frequency band f1 and receives using the second frequency band f2, the relay base station 103 or any relay base station is not capable of communicating with a mobile station as the mobile station 101 unless the mobile station is adapted to invert the uplink and downlink frequencies.

The main advantage of the embodiments is that the frequency division duplex backhauling allows an extended coverage of sparsely populated areas and allows the communication between remote access base stations and a master base station without deploying an expensive physical layer as, e.g. fiber optic. Another advantage is that the base station transmits into the same frequency and receives also into the same frequency band, and avoids a simultaneous transmission and reception into the same radio frequency, a technique that is very complex and expensive to implement. A further advantage is that there is no need of designing a complete different relay base station, as most of the hardware used in the access base station and the master base station can also be adapted to build the relay base station. It is only required to invert the transmission and reception carrier frequencies or, alternatively, to use a different transmitter and receiver hardware. A further advantage is that the inband backhauling using relay base station allows a fast network rollout and can be easily deployed in areas without a fixed infrastructure.

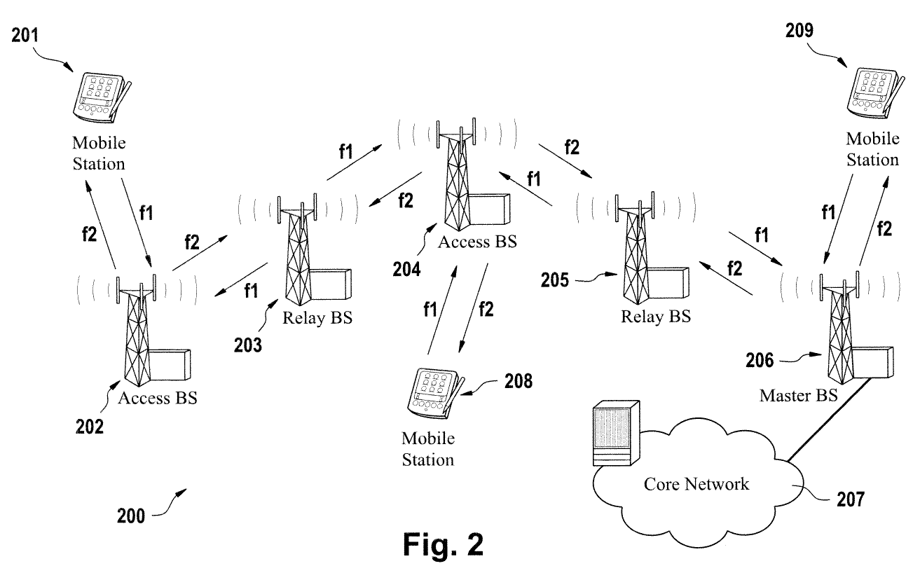

FIG. 2 shows a second example of an FDD inband backhauling according to an embodiment of the invention. The mobile communication system 200 comprises a mobile station 201 coupled to a first access base station 202, the access base station 202 coupled to a relay base station 203, the relay base station 203 coupled to a second access base station 204, the second access base station 204 coupled to a relay base station 205 and to a first mobile station 208, the relay base station 205 coupled to a master base station 206; the master base station 206 coupled to a core network 207 and to a second mobile station 209.

When a base station as the first base station 202 is located in a sparsely populated area from the master base station, or from the connection to the core network, one or more relay base stations may be needed in order to backhaul the information received and transmitted by the access base station. In the mobile communication system 200 there are two relay base stations 203, 205 that allow the remote connection between the access base station 202 and the core network 207. Between both relay base stations there is a second access base station 204 that permits the mobile station located between the area of the relays 203 and 205 to communicate as well with the core network, as it is the case of the second mobile station 208.

In the cellular communication system 200, the transformation or the inversion of the frequency bands between the uplink and the downlink bands is carried in a way that, for example, in the downlink direction from the core network 207 and the master base station 206 the signal using a second frequency band f2 is transmitted to a relay station 205 that inverts the frequency band and communicates with a second access base station 204 using the first frequency band f1. The same process is repeated in the access base station 204 to mix the signal using the second frequency band to a first relay base station 203. The process is repeated between the relay base station 203 and the access base station 202, where the first frequency band f1 is used as the carrier frequency of this first signal to communicate with the access base station 202. Finally, the access base station 202 communicates in the downlink with the mobile station 201 using the second frequency band f2.

In the cellular communication system 200, the access base station 202, the second access base station 204, as well as the master base station 206 are able to communicate with the mobile stations 201, 208 and 209. Between the base stations and the mobile station, the frequency bands that are used in the uplink and the downlink are at the same frequency bands that the mobile stations use to communicate with the base stations. As it can be seen from FIG. 2 all mobile stations communicating with an access and master base station uses an uplink with the frequency band f1 and a downlink with the frequency band f2. For all base stations, including the relays, the access and the master base station, the transmission uses only one frequency band. For example, the access base station 204 transmits to both relay base stations 203 and 205 using the second frequency band f2 and receives from said relay base station using only the first frequency band f1.

The organization of the frequency bands has a great advantage as the base stations do not require to transmit and receive simultaneously using the same frequency band, as the transmission and the reception is always completed using different frequency bands, as is the case of f1 and f2. This is also true for all base stations that belong to the inband backhauling. Another advantage is that the same frequency bands that are used to communicate with a mobile station are the ones used to transport data from the access base stations up to the core network, so that there is no extra frequency band required for the communication between the base stations. This is a special advantage for communication systems that have a medium density amount of subscribers and contain unused capacity for a connection.

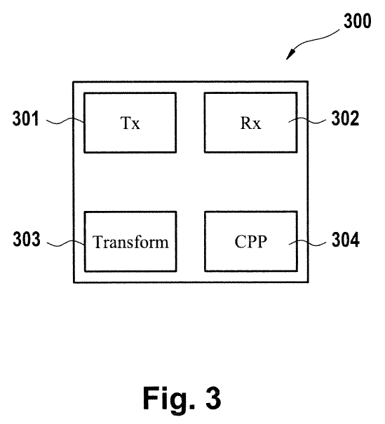

FIG. 3 shows a block diagram of a relay base station 300 comprising means for transmitting 301 a first or a second signal s1, s2 on a first frequency band f1 to a master base station or an access base station; means for receiving 302 the first or the second signal s1, s2 using the second frequency band f2 from a second and third base station, wherein the second and third base stations can be a master, an access or another relay base station. The relay base station 300 further comprises means for transforming the second frequency band f2 of the first or second signal s1, s2 into the first frequency band f1. Because the signals received from master and access base stations use the same frequency band, they must be separated in another domain, e.g. time domain (frame), subcarrier domain (OFDMA) or code domain (CDMA).

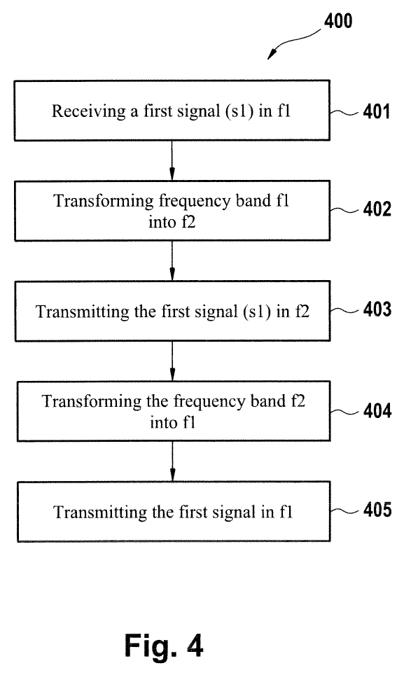

FIG. 4 shows a flow diagram of an FDD inband backhauling method for establishing a wireless transmission from at least one access base station to a master base station in a digital cellular communication system. The first step 401 of the method receives a first signal s1 by the access base station from the mobile station using a first frequency band f1. The second step 402 transforms the first frequency band f1 of the first signal s1 into the second frequency band f2 by the access base station. The third step 403 transmits the first signal s1 from the access base station to the relay base station using the second frequency band f2, wherein the access base station is designed for transmitting using the second frequency band f2. The forth step 404 transforms the second frequency band f2 of the first signal s1 into the first frequency band f1 by the relay base station, wherein the relay base station is designed for transmitting using the first frequency band f1. Finally, the fifth step 405 transmits the first signal s1 from the relay base station to the master base station using the first frequency band f1.

List of Reference Numerals

| | |
|---|---|
| 100 | Block diagram |
| 101 | Mobile station |
| 102 | Access base station |
| 103 | Relay base station |
| 104 | Master base station |
| 105 | Core network |
| 200 | Block diagram |
| 201 | Mobile station |
| 202 | First access base station |
| 203 | FirstRelay base station |
| 204 | Second access base station |
| 205 | Second relay base station |
| 206 | Master base station |
| 207 | Core network |
| 208 | Second mobile station |
| 209 | Third mobile station |
| 300 | Relay base station |
| 301 | Means for receiving |
| 302 | Means for transforming |
| 303 | Means for transmitting |
| 400 | Flow diagram |
| 401 | First step |
| 402 | Second step |
| 403 | Third step |
| 404 | Forth step |
| 405 | Fifth step |

1. An FDD Inband backhauling method for establishing a wireless transmission from at least one access base station to a master base station in a digital cellular communication system, said access base station coupled to at least a mobile station, said access base station coupled to a relay base station, said relay base station coupled to said master base station, said master base station coupled to a core network, said method comprising the steps of:
receiving a first signal by said access base station from said mobile station using a first frequency band;
transforming said first frequency band of said first signal into said second frequency band by said access base station;
transmitting said first signal from said access base station to said relay base station using said second frequency band, wherein said access base station is adapted for transmission using said second frequency band;
transforming said second frequency band of said first signal into said first frequency band by said relay base station, wherein said relay base station is adapted for transmission using said first frequency band;
transmitting said first signal from said relay base station to said master base station using said first frequency band.

2. The method as in claim 1 further comprises the steps of:
receiving a second signal by said relay base station from said master base station using said second frequency band;
transforming said second frequency band of said second signal into said first frequency band by said relay base station;
transmitting said second signal from said relay base station to said access base station using said first frequency band;
transforming said first frequency band of said second signal into said second frequency band by said access base station;
transmitting said second signal from said access base station to said mobile station using said second frequency band.

3. The method as in claim 1, wherein said digital cellular communication system complies with the IEEE 802.16 and/or Long Term Evolution standards.

4. The method as in claim 1, wherein said base stations further comprises a directional antenna for extending signal transmission reach.

5. A method as in claim 1 wherein the method is performed by a computer program product stored on a computer usable medium, comprising computer readable program means for causing a computer to perform the method when said program is run on said computer.

6. A first relay base station in a digital cellular communication system, said cellular communication system further comprising an access base station coupled to said first relay base station, wherein said access base station is adapted to communicate with a plurality of mobile stations, wherein said first relay base station is coupled to a second base station, said first relay base station comprising:
means for receiving a first signal from said access base station using said second frequency band, wherein said first relay base station is adapted for receiving using said second frequency band;
means for transforming said second frequency band of said first signal into said first frequency band, wherein said first relay base station is adapted for transmitting using said first frequency band;
means for transmitting said first signal to said second base station using said first frequency band.
means for receiving a second signal from said second base station using said second frequency band;
means for transforming said second frequency band of said second signal into said first frequency band;
means for transmitting said second signal to said access base station using said first frequency band.

7. A first relay base station as in claim 6, wherein said second base station is a master base station, said master base station is coupled to a core network, said master base station adapted for communicating from a plurality of access base station within said digital cellular communication system, wherein said master base station is adapted to communicate with a plurality of mobile stations.

8. The first relay base station as in claim 6, wherein said second base station is coupled to a third relay base station, said third relay base station coupled to a master base station, said master base station adapted for receiving communication from and transmitting to a plurality of access base station within said digital cellular communication system, wherein said master base station is adapted to communicate with a plurality of mobile stations.

9. The first relay base station as in claim 8, wherein said second base station is adapted to communicate with a plurality of mobile stations.
